(19) United States
(12) Patent Application Publication
(10) Pub. No.: US 2019/0316993 A1
(43) Pub. Date: Oct. 17, 2019

(54) DISPOSABLE CONTAINER FOR STAINS OR REAGENTS FOR STAINING MACHINES OF BIOLOGICAL MATERIAL AND STAINING SYSTEM COMPRISING SAID CONTAINER

(71) Applicant: DIAPATH S.P.A., Martinengo BG (IT)

(72) Inventors: Carmelo LUPO, Martinengo BG (IT); Alberto BATTISTEL, Martinengo BG (IT); Federica BERGAMINI, Martinengo BG (IT); Vladimiro BERGAMINI, Martinengo BG (IT)

(21) Appl. No.: 16/471,037

(22) PCT Filed: Dec. 20, 2016
(86) PCT No.: PCT/IB2016/057838

§ 371 Date: Jun. 19, 2019

(51) Int. Cl. G01N 1/31; B01L 3/00

(52) U.S. Cl. CPC G01N 1/31; G01N 2001/315; B01L 3/523

(57) ABSTRACT

A disposable container (1) for staining or reagent liquid for histological staining machines (100) is described, said staining machines comprising at least one tank (10) delimited on top by an edge (10a) and adapted to contain a staining or reagent liquid. The container (1) comprises a hollow body (1a) defining an inner volume (V) delimited by an end edge (1b), at least one staining or reagent liquid (L) contained in said inner volume (V) and a covering element (2) adapted to seal the inner volume (V). The hollow body (1a) of the container is shaped so as to be insertable inside a tank (10) of a staining machine (100) and the end edge (1b) is shaped substantially complementary to the edge (10a) of the tank (10). A system comprising at least one container according to the present invention and at least one tank for stain or reagent of a staining machine, is also described.

### FIELD OF THE INVENTION

The present invention relates to the field of the automated staining machines wherein stains and reagents are used to provide sufficient contrast among the microscopic structures of a biological tissue when the latter is placed under observation. In particular, the present invention relates to a container for stains or reagents to be used in the staining machines of biological material. The invention also relates to a system comprising at least one container according to the present invention and at least one tank for stain or reagent of a staining machine.

### PRIOR ART

A staining machine of biological material, also commonly called “stainer”, is a manual, automated or semi-automated device able to stain a biological sample arranged on a slide, such as for example a sample of tissue, organ or part of an organ, so as to allow the anatomic-pathologic diagnosis of the biological sample under examination.

By “anatomic-pathologic diagnosis” is meant the result of the interpretation by the anatomic pathologist of morphological, macroscopic and microscopic characteristics of the biological sample under examination.

As it is known, the sample under examination must be optimally prepared and preserved in order to provide accurate and complete diagnoses. However, from the moment the sample is excised by the subject to the moment it is suitably treated with “fixation or freezing” methodologies, both the tissue architecture (subject of histology study) and the morphological characteristics of the cells making thereof (subject of cytology study) can undergo degradation and alteration processes. This degradative process, if not properly controlled, can distort or hinder the diagnosis. Therefore the preparation and preservation of the samples become a priority in order to assure correct and complete diagnoses, but likewise a priority is their storage during time to fulfill possible requests of the patient needing the preparation for further analysis or other clinical needs.

When the pathologist receives the sample (for example a tissue, an organ or a part thereof), it enters a multistage process commonly called “workflow” finalized to the histo-cytopathologic diagnosis, which makes use of technologies and processes, by now normally automated. The diagnosis is only possible after the completion of the last stage of the process, i.e. the observation under the optical microscope of a micrometer section obtained from the sample. The workflow is known in the art and commonly provides for, in a predetermined order, a series of steps going from the tissue preparation to the staining and assembling on the slide for the observation. Particularly important in the workflow process is the staining step, as the insufficient contrast amongst macroscopic tissue structures would make impossible to observe them. For this reason, the sample is previously stained in order to highlight the structures of cells and tissues.

Various stains exist and, among the various staining, the most commonly used is the combination between acid stains, such as for example eosin, and basic stains, such as for example hematoxylin. The acid stains are bound to acidophilus components of the tissue, such as for example cytoplasm and proteins, whereas the basic stains are bound to basophil components of the tissue such as for example DNA and RNA. Also, there are neutral stains interacting with substrates free of electric charge, such as for example the lipids.

Following the observation of the morphological characteristics on the section stained in hematoxylin/eosin, it is possible to perform subsequent staining on further section of tissue, named “special staining” or “histochemical staining”, which are able to highlight specific cellular or tissue constituents useful for making the diagnosis.

Once the staining is completed the slide must be “assembled”, i.e. protected by a cover slip so to guarantee the preservation over time. The slide, once correctly assembled, is subjected to the observation under the optical microscope in order to make the diagnosis of the tissue under examination.

The various processing and staining steps require times that are by now conventionally established, either they are manually made or automated instruments are used. Respecting the treatment timing for making the diagnosis and for the reproducibility of the results is of paramount importance.

The advantage of using an automated mechanical staining instrument lies in the possibility to manage at the same time a greater number of samples (also up to 300) and to free the operator from the need to manually manage the staining steps in accordance with technical timing, thereby optimizing the human resources within the lab.

Automated staining machines constituted by a mechanical arm moving on a series of tanks filled with reagents and stains are known. The mechanical arm moves the racks in which the slides are housed (commonly known as slide racks) with the sections or cells to be stained. The racks are automatically immersed, for a convenient period of time and consecutively, in various tanks containing the reagents for the staining and already placed in the established order.

Known automated staining machines can be of four main models, a carousel model (wherein the racks, wherein the slides are housed, are immersed in circularly placed tanks), a linear model (wherein the racks, in which the slides are housed, are immersed in linearly placed tanks), a translating closed-system model (wherein the racks, in which the slides are housed, are moved along the transverse and longitudinal axes of the machine so that to be placed in stations provided with staining tanks and drying stations) and finally a nebulized spray model (wherein reagents and stains are directly sprayed on the slide by means of an automated nebulizer).

All of the carousel, linear and translating models comprise at least one station with a tank containing stain.

Also by employing automated instrumentation, the preparation of the samples for cytological, histological and/or autoptical examinations provides for several steps divided into processing steps and staining steps of the samples. Therefore it is necessary a lot of time and, in general, it is has been estimated that for setting up 30 samples on average about 20 hours are needed, divided in two working days.

The optimization of the working times is invalidated by the routine maintenance of the instrument, and such a task is entrusted to the operator. On average the staining solutions are replaced every three days or based on the frequency of use of the instrument, because of the contaminations due to the immersions of the slide rack in contiguous tanks of different stains. Furthermore, the replacement of the stain presupposes the washing of the tank because of the solid deposits on the bottom and in the edges of the container (precipitation of the stain). The washing of the tanks, even if brief, implies the temporary stop of the workflow of the sample (about every three days), because of the impracticality of the instrument for the time needed for the washing.

The drawback is more important with some stains, such as hematoxylin, eosin and EA50, that permanently stain the tanks. A sanitization process of all of the tanks, by washing in sodium hypochlorite solution or in convenient solvent, is necessary on average once every 20 days or based on the use of the stainer, thus causing the interruption of the activity for a period of time of minimum 12 hours. However, even after this treatment, the stain still remains on the tanks used during the staining step. It is a purpose of the present invention to reduce the time of the known staining processes in a staining machine for the preparation of the samples for cytological, histological and/or autoptical examinations. In particular, it is a purpose of the present invention to optimize the maintenance operations of the known staining machines, by reducing the time needed to the replacement process of the stain inside the tanks, for example caused by the contamination due to the immersion of the slide rack in contiguous tanks of different stains.

It is a further purpose of the present invention to facilitate the operations relative to the preparation and use of a staining machine, in particular by reducing the washing times of the stain tanks by the operator and thus reducing maintenance costs of the staining machines.

### SUMMARY OF THE INVENTION

These and other purposes of the present invention are achieved by a disposable container for staining or reagent liquid that is used in staining machines comprising at least one tank delimited on top by an edge and adapted to contain a staining or reagent liquid. The disposable container comprises a hollow body defining an inner volume delimited by an end edge, at least one staining or reagent liquid contained in the inner volume and a covering element adapted to seal the inner volume.

The hollow body of the container is shaped so as to be insertable inside said tank of the staining machines and the end edge of the hollow body of the container is shaped substantially complementary to the edge of the tank.

The container adapted to contain a staining or reagent liquid is, according to the present invention, a container adapted to be used and disposed after use. In other words, the container according to the present invention is of the single-use type.

The hollow body of the container according to the present invention is inserted in the tank of the staining machine through the upper opening delimited by the edge of the tank. In this way, the container containing the staining or reagent liquid can be overlapped to the empty tank of the staining machine and thus the stain or reagent is not inserted directly in contact with the inner surface of the tank, as it happens with the machines known in the art.

In fact, according to the known art, the tank of the staining machine is filled with staining or reagent liquid whereas, according to the present invention, the tank is intended to accommodate the disposable container that, as stated, is shaped (configured) so to be able to be inserted inside the tank. The end edge of the container is substantially complementary to the edge of the tank and preferably is shaped (configured) so as to be able to be overlapped (superimposed) to the end edge of the tank.

In fact, according to an aspect of the present invention, the end edge is rested, in use, on the end edge of the tank.

Furthermore, according to an aspect of the present invention, the hollow body of the disposable container is substantially complementary to the inner volume of the tank of the staining machine, preferably the hollow body is shaped so as to substantially occupy the entire inner volume of said tank.

Advantageously, the container according to the present invention allows reducing the times of the staining processes, as it allows eliminating the times required for maintaining and cleaning the tanks containing the staining or reagent liquid. In particular, the container according to the present invention allows eliminating the times required for the replacement of the stain inside the tanks and eliminating the need to wash the tanks for removing the stain in addition to the contaminations due to the immersions of the slide rack in contiguous tanks of different stains. According to an aspect of the present invention, the end edge of the container can comprise at least one supporting notch (or seat) adapted to accommodate a slide rack.

Advantageously, the slide rack, in other words a rack comprising at least one seat adapted to accommodate one or more slides in which biological material to be treated is placed in said staining machines, can be housed inside the container containing the staining or reagent liquid, being stably rested on one or more notches (or seats) obtained on the end edge of the container according to the present invention.

According to another aspect of the present invention, the end edge of the container can comprise a portion of folded edge facing outside of the container.

Advantageously, the edge portion that is folded and is facing outside of the end edge of the container allows facilitating the positioning of the container inside the tank of the staining machine and allows inserting the edge of the tank inside the fold of the end edge of the container.

Furthermore, the folded edge portion facing outside of the end edge of the container ensures the protection of the tank of the automated staining machine against a possible drip of the staining or reagent liquid on the edge of the tank.

According to a further aspect of the present invention, the covering element of the container can be a film adhering to the end edge of the container.

Advantageously, the film seals the inner volume of the hollow body of the container by protecting the content thereof, i.e. the staining or reagent liquid, from external contaminations and impeding spills of liquid to the outside.

Furthermore, the covering film of the container also allows selling and transporting the container so that the container already contains the staining or reagent liquid before being inserted inside the corresponding tank of the staining machine. In this way, the present invention allows to abolish the preparation and maintenance times of a staining machine linked to the filling, emptying and cleaning of the tanks of the staining machine.

Furthermore, according to an aspect of the present invention, the covering element adapted to seal the inner volume of the hollow body, such as for example a film, is non-reversibly removable. In other words, once the covering element is removed, it is not possible to apply it again so that to seal the inner volume of the hollow body of the disposable container.

According to an aspect of the present invention, the container and particularly the hollow body thereof is made of non-transparent material, or it is protected by non-transparent material applied to the hollow body. In other words, the hollow body of the container cannot be crossed by the light radiation. The shield to the passage of light enables to efficiently preserve the staining or reagent liquid contained therein. According to an aspect of the present invention, the hollow body of the container presents dark color so as to protect the liquid contained inside it from the passage of light radiation.

The present invention also relates to a staining system (or assembly or kit) of biological material for staining machines comprising at least one tank delimited on top by an edge and adapted to contain a staining or reagent liquid and at least one disposable container according to the present invention. In particular, the container of the system, that in use is intended to be inserted in the tank through the opening delimited by the upper end edge of the tank, comprises a hollow body defining an inner volume delimited by an end edge, at least one staining or reagent liquid contained in the inner volume and a covering element adapted to seal the inner volume. The hollow body of the container is shaped so as to be insertable inside the tank of the staining machines and the end edge of the container is shaped substantially complementary to the edge of the tank.

Advantageously, the container according to the invention is conveniently sized substantially complementary to the tanks of the staining machines so as to be able to be housed inside the cavity of the tank.

Obviously, the characteristics described and/or claimed with reference to the container can be referred to the system, or assembly, comprising the tank of the staining machine and the container, and vice versa.

The present invention also relates to a process for the automated staining of biological material for staining machines, comprising the steps of:

a) introducing a first container containing a staining or reagent liquid inside said tank;

b) extracting said first container from said tank after use or when changing the stain or reagent is desired;

c) introducing inside said tank a second container.

Furthermore, said process can comprise the steps of:

d) removing a covering element adapted to seal the inner volume of said container, said step d) being carried out before step a) or between said step a) and step b); and

e) reading or detecting data relative to an identification element associated with said container and the staining or reagent liquid contained therein.

According to an aspect of the present invention, the process can comprise the steps of:

f) introducing a slide rack inside said container, said step f) being carried out between said step a) and said step b) or else after said step c);

g) extracting said slide rack from said container, said step g) being carried out after said step f);

h) repeating the steps f) and g) until the staining or reagent liquid reaches a determined level of contamination and/or deterioration, or the liquid is depleted;

i) disposing said first disposable container, said step i) being carried out after said step b).

Advantageously, the process for the automated staining of biological material according to the present invention allows disposing the container and the contaminated and/or deteriorated staining or reagent liquid by eliminating the times that, at present, are required in the known machines for cleaning the tank of the automated staining machine and for filling the tank with a new staining or reagent liquid.

A further advantage of the present invention consists in that the container adapted to contain the staining or reagent liquid can be used in the ways indicated by the steps of the process of the present invention, with the manual or automated staining machines of the known art, among which for example the linear, carousel and translating staining machines. In other words, it is possible to use the container of the present invention directly on the staining machines of the known art without the need to have new staining machines or further interfacing means between the staining machines, or the tanks thereof, and the container according to the present invention.

The present invention also relates to a staining machine comprising at least one tank for the stain or reagent and at least one container according to the present invention. Obviously, the characteristics described and/or claimed with reference to the container or the system, or assembly, comprising the tank of the staining machine and the container, can be referred to the staining machine, and vice versa.

### BRIEF DESCRIPTION OF THE FIGURES

Further characteristics and advantages of the present invention will be more evident in the following description, for illustrative purposes and referring to the attached figures, wherein:

FIG. 1 shows a possible embodiment of an automated histological staining machine of the known art;

FIG. 2a shows a container adapted to contain a staining or reagent liquid according to the present invention;

FIG. 2b shows a possible embodiment of a tank for a staining machine;

FIG. 3a shows the container of FIG. 2a inserted inside the tank of FIG. 2b;

FIG. 3b shows the removal step of a covering element of the container of FIG. 2a;

FIGS. 4 and 4a respectively show a side view and a top view of a possible embodiment of a tank according to FIG. 2b for a staining machine.

### DETAILED DESCRIPTION OF THE FIGURES

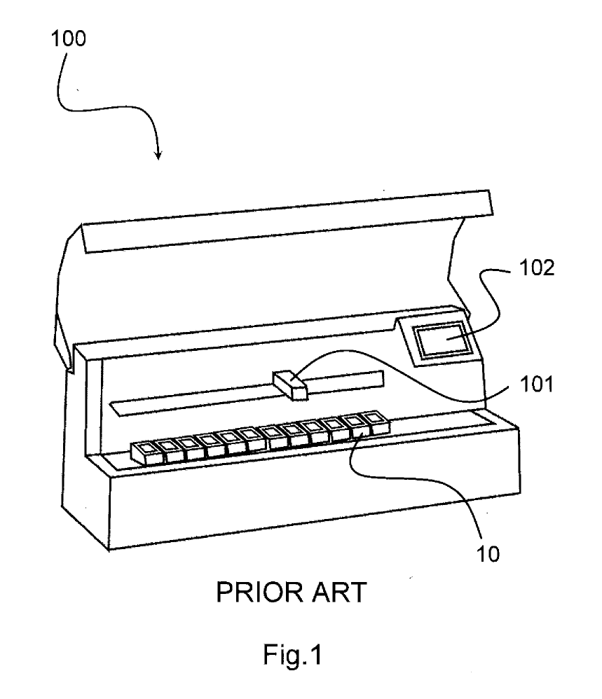

With reference to FIG. 1, the staining machine 100 for histological, cytological and/or histochemical uses, can be an automated linear staining machine belonging to the known art. In fact, a linear staining machine, such as for example that one shown in FIG. 1, comprises tanks 10 adapted to contain a staining or reagent liquid to be used for staining biological material.

Please note that, in FIG. 1 and herein below, reference is made to an automated linear staining machine 100, but that for the purposes of the present invention, it is possible to make reference to any other manual or automated staining machine 100 equipped with tanks 10 adapted to contain a staining or reagent liquid for the immersion of a slide rack therein. For example, the disposable container 1 according to the present invention can be used in automated staining machines 100 of carousel or translating models, or else in a manual staining machine, even if not shown in the appended figures.

As shown in FIG. 1, the staining machine 100 comprises a mechanical arm 101 able to move a slide rack, not shown in figure, inside a determined series of tanks 10. Therefore, the biological material contained in the slides of the rack is subjected to a predetermined staining treatment. The racks are automatically and consecutively immersed in the tanks 10 for a convenient period of time, in various tanks 10 placed according to the established order. A specialized operator can intervene in controlling the staining machine 100 by operating determined control means, such as for example a command interface 102.

As it is known, the staining machine 100 can repeat the desired number of times a staining cycle for different samples of biological material to be stained, thereby allowing a significant increase in the number of slides of biological material treated in the time unit.

Because of the immersion of the slide rack in different tanks 10 containing different types of staining or reagent liquids, the liquids contained in the different tanks 10 are subjected to contamination by the other staining or reagent liquids and/or biological material treated inside the tanks 10, and/or are subjected to natural deterioration.

For this reason, based on the frequency of usage of the automated staining machine 100 at full use, usually it is necessary to replace the staining or reagent liquid inside the tanks 10 every three days. Furthermore, because of the precipitation of the contaminated and/or deteriorated stain on the bottom of the tanks 10, it is necessary to proceed with the washing of the tanks 10 before proceeding to the filling of the latter with new staining or reagent liquid.

In summary, the automated staining process of the biological material according to the known art provides for filling the tanks 10 with the staining or reagent liquid adapted for the staining of the biological material; staining the biological material by a series of immersions inside the tanks 10; emptying the tanks 10 from the contaminated and/or deteriorated staining or reagent liquid; cleaning, for example by washing, the tanks 10; filling the tanks 10 with new staining or reagent liquid.

In particular, as already previously discussed, the steps of emptying the tanks 10 from the staining or reagent liquid; cleaning the tanks 10 and filling the tanks 10 with the staining or reagent liquid, will be expensive both from a point of view of the time required to complete the operations, and from a point of view of hard work and effort required to the specialized operator in order to complete the operations.

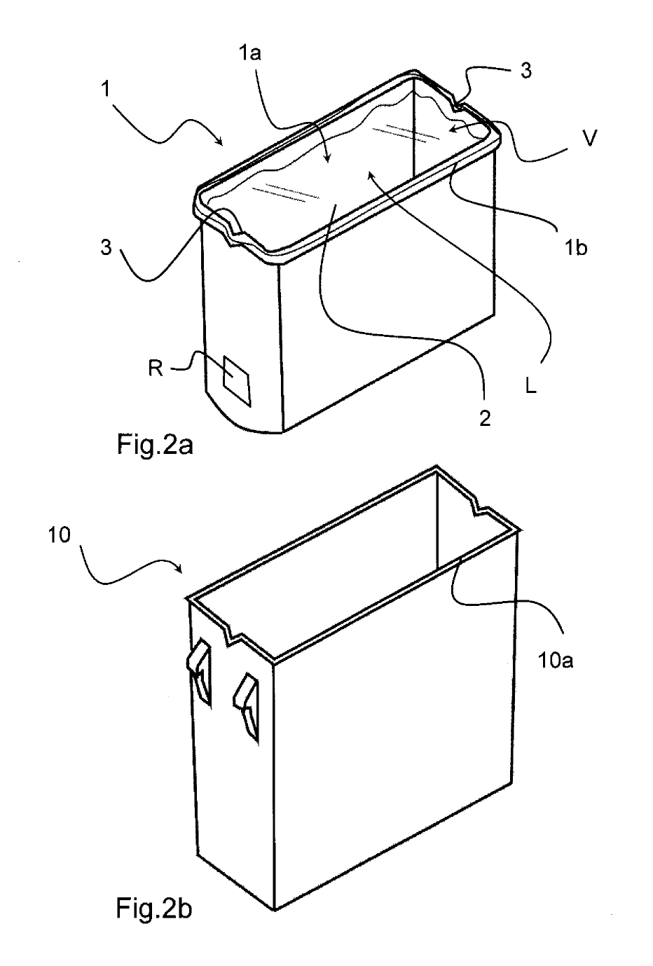

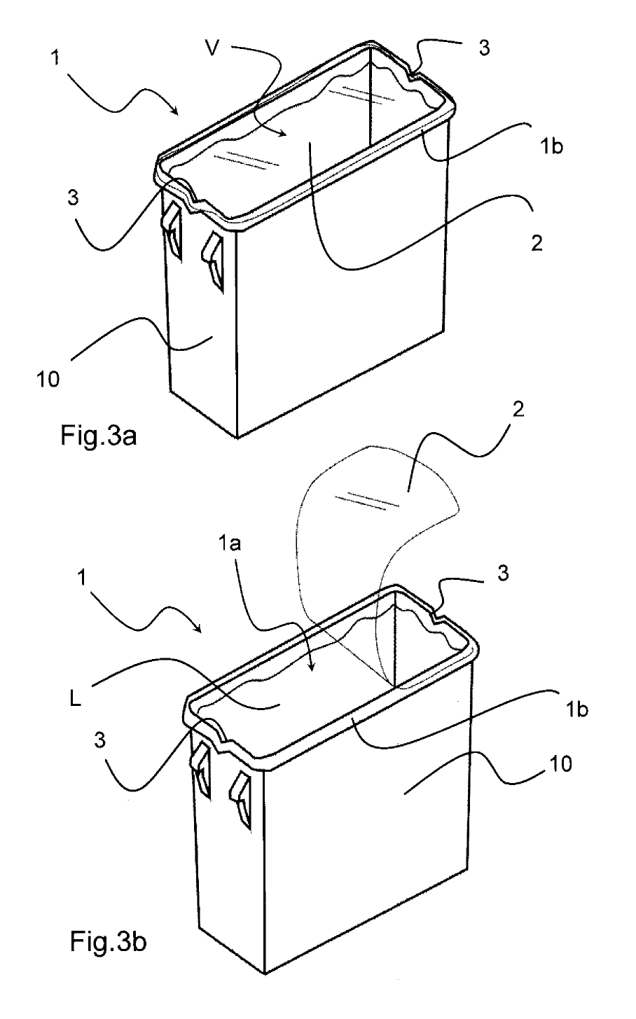

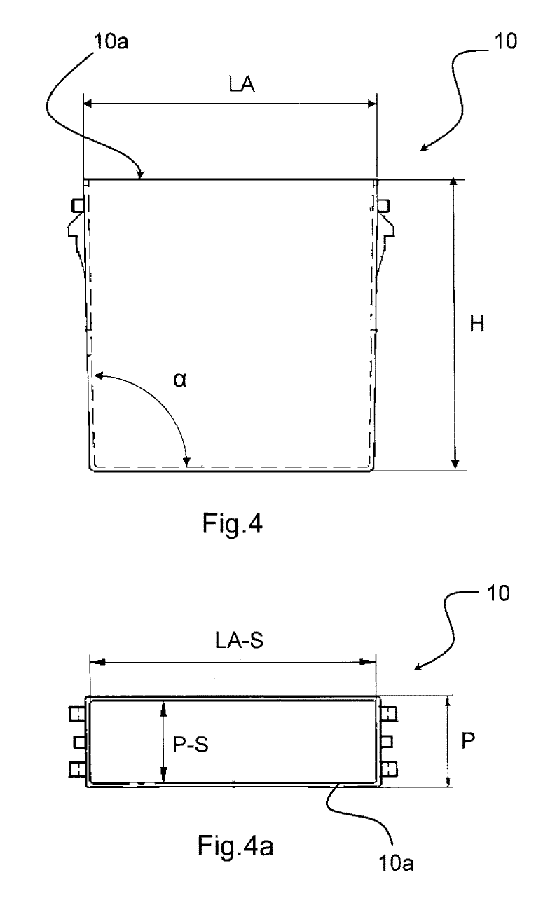

With reference to FIGS. 2a-b, 3a-b, the disposable container 1 for histological staining machines 100 can be inserted inside a traditional tank 10 shown in detail in FIG. 2b and in FIGS. 4-a and adapted to contain a staining or reagent liquid.

At the end of use of the disposable container 1 inside the staining machine 100, it is possible to dispose the container 1 and replace it inside the staining machine 100 with a new container 1, itself also disposable.

With reference to FIG. 2a, the disposable container 1 is shaped so as to be insertable, in use, inside a tank 10 of a staining machine 100.

In particular, the shape and dimensions of the disposable container 1 are such that it is possible to insert the hollow body 1a of the container 1 inside a tank 10 of a staining machine 100.

Typically, the shape of a tank 10 of a staining machine according to the known art has rectangular base so as to form a hollow solid having outer shape substantially of parallelepiped, wherein the upper surface is open and delimited by the upper edge 10a (see for example FIGS. 2b, 4 and 4a).

It should be noted that the lateral walls departing from the lower base surface, for their extension towards the open upper surface, can be perpendicular to the base surface or else can form a tilt angle (see for example angle a in FIG. 4). Such an angle, where present, is preferably small in the order of one degree or some degrees. The dimensions of the tank 10 in height H (measured from the lower surface to the upper edge 10a), width LA (measured at the major lateral wall at the upper edge 10a) and depth P (measured at the minor lateral wall at the upper edge 10a), for example shown in FIGS. 4 and 4a, are generally within the ranges of: height H between about 140 mm and 110 mm (preferably between about 133 mm and 120 mm), depth P between about 35 mm and 50 mm (preferably between about 41 mm and 45 mm), width LA between about 140 mm and 120 mm (preferably between about 134 mm and 125 mm).

The thickness S of the walls of the tank 10, by which the inner dimensions of the upper opening delimited by the upper edge 10a are obtained by subtracting from the measures of the width LA and depth P the measure of the thickness (LA−S) and (P−S), can be between about 4 and 1 mm, preferably between 2 and 3 mm, the container according to the present invention being inserted through such an opening (see for example FIG. 4a).

According to a possible embodiment, a tank 10 of a staining machine can have height H of about 133 mm, depth P of about 41.5 mm, width LA of about 134 mm and wall thickness S of about 2 mm.

According to another possible embodiment, a tank of a staining machine can have height of 120 mm, depth of 45 mm, width of 125 mm and wall thickness of 3 mm.

The hollow body 1a of the disposable container 1 is substantially complementary to the inner volume of said tank 10. In other words, the shape and dimensions of the container 1 are similar to those of the tank 10 and such to allow inserting the container 1 inside the tank 10, preferably by maximizing the occupied volume i.e. by enabling the housing of the greatest amount of liquid L while enabling an easy insertion/removal of the container from the tank.

Therefore the disposable container 1 can have shape similar to that of a tank 10, for example a rectangularly shaped tank as described above. In other words, the disposable container 1 can have shape similar to that of the tank, for example with rectangular base, with slightly lower dimensions than those of a corresponding tank 10, so to allow its insertion therein. Furthermore, the protruding edge of the container 1 will have such dimensions to be able to accommodate the housing of the container 1 inside tanks 10, even when the tanks 10 have slightly variable dimensions.

Furthermore, the hollow body 1a can substantially entirely fill the inner volume of the tank 10 of the staining machine 100. The dimensions and shape of the hollow body 1a of the container are advantageously selected to allow inserting the small tank by maximizing the volume available for the staining or reagent liquid, and thus leaving a minimal clearance between the outer surface of the hollow body 1a and the inner surface of the inner hollow volume of the tank to allow the insertion/removal thereof.

According to other embodiments, the shape of the container 1 can be different from that of the tank 10 of the staining machine 100, for example the hollow body 1a of the container 1 could not entirely fill the inner volume of the tank 10.

The hollow body 1a of the container 1 defines an inner volume V delimited by an end edge 1b at least in part shaped substantially complementary to the edge 10a of the tank 10.

According to a possible embodiment, the edge 1b of the container 1 has such a shape to cover the surface of the edge 10a of the tank 10. In other words, the edge 1b of the container 1 can be coupled to the edge 10a of the tank 10 thorough a shape-interference couple.

In particular, as for example shown in detail in FIG. 2b, if the edge 10a of the tank 10 is a closed edge with rectangular shape and for example with transverse profile like an upside-down “U”, the end edge 1b of the container 1 is substantially a rectangularly-shaped closed edge (i.e. a perimetrical edge), for example with at least one part of the transverse profile like an upside-down “U”.

The end edge 1b of the container 1 can comprise a folded edge portion facing outside of said container 1. The edge portion that is folded is shaped substantially complementary to the shape of the edge 10a of the tank 10 of the staining machine 100.

The folded portion of the end edge 1b facilitates inserting and extracting the container 1 with respect to the tank 10 of the staining machine 100. Furthermore, the folded portion of the end edge 1b, facing outside the container 1, allows avoiding the tank 10 to get dirty, for example because of the drip of staining or reagent liquid from the container 1 inside the tank 10.

According to an embodiment not shown in the attached figures, the end edge 1b of the container 1 can comprise gripping means of the container 1, such as for example handles or protrusions, to facilitate the grip of the container 1 by the operator in the steps of inserting the container 1 inside the tank 10 and extracting the container 1 from the tank 10.

The container 1 further comprises a covering element 2 adapted to seal the inner volume V of the container 1 at the end edge 1b.

According to the embodiment shown in the attached figures, the covering element 2 is for example a film adhering to the end edge 1b. The film is light, can be easily removed, has negligible bulk and at the same time allows the hermetic seal of the container 1 during selling, transporting and storing the container 1. In this way, the content of the container 1, such as for example the staining or reagent liquid, is isolated from possible contaminations or deterioration operated from the outside and is confined inside the volume V of the container 1.

The container 1 can be made of any material suitable for the use, in other words suitable to contact and contain a staining or reagent liquid L.

According to a preferred embodiment, the container 1 can be made of plastic material. More preferably, the container 1 can be made of PET, polypropylene or the like.

Advantageously, the plastic material the container 1 can be made of is light, cheap and recyclable.

According to an aspect of the present invention the container, and particularly the hollow body thereof, is made of non-transparent material, or is protected by non-transparent material applied to the hollow body. In other words, the hollow body of the container cannot be crossed by the light radiation. The shield to the passage of light enables to efficiently preserve the staining or reagent liquid contained therein.

According to an embodiment, the material the container 1 can be made of can be dark. In other words, if the container 1 is made of plastic material, said plastic material is manufactured so that to show a dark color with the purpose of protecting the stain and/or reagents against external radiations, such as for example the sunlight. The container 1 can further comprise at least one identification element R applied on the surface of the container, to allow the identification of the container 1 itself.

In particular, an identification element R of the container 1 can be a code, a data matrix, a bar code, a QR code, or any other identification element easily identifiable by the operator or detection means used by the operator. Preferably, the identification element R associated with the container 1 is a RFID (Radio Frequency Identification) element. The RFID technology has the advantage of reducing the human mistake in recognizing the container 1, identifying the container 1 and remotely categorizing it.

The identification element of the container 1 allows identifying the type of stain and/or reagent contained inside the container 1, thus allowing to identify and control the characteristics of the liquid L therein. Furthermore, the identification element allows controlling the expiring dates of the liquids contained in the container 1, the number of samples of biological material subjected to the staining treatment inside the container and, in general, to provide complete traceability of the transport, storing, use and disposal operations.

The identification element of the container 1 can be applied on the surface of the container 1 by constraining means, such as for example an adhesive, or be incorporated in the container 1.

Herein below the steps of the histological staining process according to the present invention are described.

A machine for the staining of biological material being provided, comprising at least one tank 10 adapted to contain a staining and/or reagent liquid, the container 1 according to the present invention is introduced inside said tank conveniently empty (i.e. free of liquid inside it).

The container 1 contains a staining or reagent liquid adapted for the staining of the biological material. The container 1 shows a covering element 2 adapted to seal the inner volume V of the container 1. The covering element, preferably a film adhering to the end edge 1b of the container 1, can be removed once the container 1 is inserted inside the tank 10. According to another embodiment, the covering element 2 can be removed before inserting the container 1 inside the tank 10. Please note that the covering element 2 of the container 1 is removed in a non-reversible way, in other words, once the covering element 2 is removed, it is not possible to apply it again so that the hermetic seal of the container 1 is made.

At this point, it is possible to proceed with the staining of the biological material by means of the staining machine 100. In particular, it is possible to introduce inside the container 1 a slide rack, on which slides the biological material to be stained is placed. The insertion of the rack can be of manual type, in other words performed manually by an operator, in case the staining machine 100 is of manual type; otherwise it can take place automatically, in other words performed by a mechanical arm of the staining machine 100, in case the staining machine 100 is of automated type.

During use, i.e. during the staining of the biological material placed in the slides of the rack immersed in the container 1, the rack is immersed in the container 1 and subsequently is extracted from the container, so that to be immersed in another container containing a reagent and/or staining liquid of the following step of the staining treatment, or else to be ready to begin the following step of the workflow of the histological analysis.

The process according to the present invention provides for the immersion of multiple racks containing biological material inside the container 1 itself.

During use, the staining or reagent liquid contained inside the container 1 is subjected to gradual deterioration and/or contamination due to the immersion of biological material previously immersed in one or more containers containing different staining or reagent liquids.

When the level of deterioration and/or contamination and/or depletion reaches a determined level, it is possible to extract the container 1 from the tank 10 of the staining machine 100 and introduce inside the tank 10 itself of the machine 100 a new container 1 containing a new staining or reagent liquid.

The extraction operation of the disposable container with used liquid and the insertion operation of the container with new liquid allow the specialized operator to rapidly change the staining or reagent liquids, to avoid slow and expensive cleaning, decontamination and periodic sanitization operations of the tanks 10 that would be needed in the process of staining the biological material according to the known art. At this point, the container 1 containing the contaminated and/or deteriorated staining or reagent liquid can be disposed of, according to current disposal regulations.

During the steps of the staining process according to the present invention, it is possible to uniquely track and identify the containers 1 used during the staining, so that to evaluate in real time a number of characteristics relating to the container 1 and the content thereof. For example, it is possible to evaluate the statistics relative to the number of processed samples, quantity and type of used reagents, to control the expiring dates of staining or reagent liquids, to uniquely identify the type of stain or reagent, to track the batch of stains or reagents, etc.

The identification step of the container 1 and the content thereof can be made for example by the use of an identification element provided with the RFID technology, that advantageously allows remotely identifying the container 1. Further identification elements, such as for example bar codes, QR codes, data matrix or other known codes, can be used for the identification of the container 1 and the content thereof by an operator, without departing from the purposes of the present invention.

In the identification step of the container 1, the specialized operator obviously makes use of a specific reader of the identification element associated with the container, such as for example a RFID reader or else a bar code reader, QR code reader o else.

1. Disposable container (1) for staining or reagent liquid for histological staining machines (100), said staining machines comprising at least one tank (10) delimited on top by an edge (10a) and adapted to contain a staining or reagent liquid, said container (1) comprising a hollow body (1a) defining an inner volume (V) delimited by an end edge (1b), at least one staining or reagent liquid (L) contained in said inner volume (V) and a covering element (2) adapted to seal the inner volume (V), the hollow body (1a) of the container being shaped so as to be insertable inside said tank (10) of said staining machines (100) and said end edge (1b) being shaped substantially complementary to said edge (10a) of said tank (10).

2. Container (1) according to claim 1, wherein said hollow body (1a) is substantially complementary to the inner volume of said tank (10), said hollow body (1a) of said container (1) being shaped so as to substantially occupy the entire inner volume of said tank (10).

3. Container (1) according to claim 1, wherein said covering element (2) seals the inner volume (V) of said hollow body at said end edge (1b).

4. Container (1) according to claim 1, wherein said covering element (2) adapted to seal the inner volume of said hollow body is non-reversibly removable.

5. Container (1) according to claim 1, wherein said covering element (2) is a film adhering at said end edge (1b).

6. Container (1) according to claim 1, wherein said end edge (1b) comprises at least one supporting notch (3) adapted to accommodate a slide rack.

7. Container (1) according to claim 1, wherein said end edge (1b) is rested, in use, on said edge (10a) of said at least one tank (10) for staining machines.

8. Container (1) according to claim 1, wherein said end edge (1b) comprises a folded portion facing outside of said hollow body (1a) of the container (1).

9. Container (1) according to claim 1, comprising an identification element (R) for identifying and tracking said container (1), wherein said identification element is of RFID type.

10. Staining system to stain biological material for histological staining machines (100), comprising:
a tank (10) delimited on top by an edge (10a) and adapted to contain a staining or reagent liquid; and
a disposable container (1) comprising a hollow body (1a) defining an inner volume (V) delimited by an end edge (1b), at least one staining or reagent liquid (L) contained in said inner volume (V) and a covering element (2) adapted to seal the inner volume (V), the hollow body (1a) of the container being shaped so as to be insertable inside said tank (10) of said staining machines (100) and said end edge (1b) being shaped substantially complementary to said edge (10a) of said tank (10).

11. System according to claim 10, further comprising at least one slide rack.

12. System according to claim 10, wherein said said hollow body (1a) of said container (1) is shaped so as to substantially occupy the entire inner volume of said tank (10).

13. Staining process to stain biological material for histological staining machines (100) of the type comprising at least one tank (10) delimited on top by an edge (10a) and adapted to contain a staining or reagent liquid, comprising the steps of:
a) introducing a first container (1) containing a staining or reagent liquid (L) inside said tank (10);
b) extracting said first container (1) from said tank (10) after use or when changing the stain or reagent is desired;
c) introducing a second container (1) inside said tank (10).

14. Process according to claim 13, comprising the step of:
d) removing a covering element (2) adapted to seal the inner volume of said container (1), said step being carried out before step a) or between said step a) and step b).

15. Process according to claim 13, comprising the step of:
e) reading or detecting data relative to an identification element (R) associated with said container (1) and the staining or reagent liquid (L) contained therein.

16. Machine (100) for staining biological material for histological use, comprising a container (1) according to claim 1, or a staining system to stain biological material comprising:
a tank (10) delimited on top by an edge (10a) and adapted to contain a staining or reagent liquid; and
a disposable container (1) comprising a hollow body (1a) defining an inner volume (V) delimited by an end edge (1b), at least one staining or reagent liquid (L) contained in said inner volume (V) and a covering element (2) adapted to seal the inner volume (V), the hollow body (1a) of the container being shaped so as to be insertable inside said tank (10) of said staining machines (100) and said end edge (1b) being shaped substantially complementary to said edge (10a) of said tank (10).
